(19) United States
(12) Patent Application Publication
(10) Pub. No.: US 2010/0003554 A1
(43) Pub. Date: Jan. 7, 2010

(54) ANODE GAS CIRCUIT OF A FUEL CELL SYSTEM AND METHOD FOR ACTIVATING AND DEACTIVATING SUCH AN ANODE GAS CIRCUIT OF A FUEL CELL SYSTEM

(75) Inventors: Peter Haushaelter, Moenchengladbach (DE); Helmut Prinz, Neuss (DE); Michael Benra, Castrop-Rauxel (DE)

Correspondence Address: DARBY & DARBY P.C., P.O. BOX 770, Church Street Station, New York, NY, 10008-0770, US

(73) Assignee: Pierburg GmbH, Neuss (DE)

(21) Appl. No.: 12/496,069

(22) Filed: Jul. 1, 2009

(30) Foreign Application Priority Data
Jul. 2, 2008 (DE) DE 102008031280.0

(51) Int. Cl. H01M 8/04; H01M 2/02

(52) U.S. Cl. 429/17; 429/34; 429/26

(57) ABSTRACT

An anode gas circuit of a fuel cell system. The anode gas circuit includes a return line leading from an anode gas outlet of a fuel cell stack to an anode gas inlet of the fuel cell stack, a recirculation blower disposed in the return line, a first valve disposed in the return line upstream of the recirculation blower, and a second valve disposed in the return line downstream of the recirculation blower. The first valve and the second valve are configured to close a cross section of the return line.

### CROSS REFERENCE TO PRIOR APPLICATIONS

Priority is claimed to German Patent Application No. DE 10 2008 031 280.0, filed Jul. 2, 2008. The entire disclosure of said application is incorporated by reference herein.

### FIELD

The present invention provides for an anode gas circuit of a fuel cell system comprising a return line extending from an anode gas outlet of a fuel cell stack to an anode gas inlet of the fuel cell stack via a recirculation pump. The present invention also provides for a method for activating and deactivating an anode gas circuit of a fuel cell system wherein anode gas is conveyed by a recirculation pump from an anode gas inlet of a fuel cell stack to an anode gas outlet of the fuel cell stack via a return line.

### BACKGROUND

Fuel cell systems are generally known. They serve to convert the chemical reaction energy of a continuously supplied fuel, such as hydrogen, and an oxidizer such as oxygen, into electric energy that may be used as propulsion energy, for example, for vehicles.

Anode gas circuits are also known with which anode exhaust gases, mainly composed of not yet consumed hydrogen, nitrogen and water vapor, may be returned to the fuel cell stack. An improved utilization of the hydrogen serving as the fuel is thereby achieved. These anode gases are conveyed by means of a recirculation blower conveying the anode gases from an anode gas outlet of the fuel cell stack to an anode gas inlet of the fuel cell stack via a return line.

Such recirculation blowers are most frequently configured as side channel blowers driven by electric motors, wherein, when used as hydrogen blowers, the components of the blowers are sealed in a special manner due to the aggressive medium. Moreover, these side channel blowers are typically designed with particularly small gaps in order to achieve as high an efficiency as possible. A blower suited for conveying hydrogen is described, for example, in DE 103 01613 A1.

In the anode gas circuit, especially with so-called PEM fuel cell systems supplied with hydrogen as the fuel, water is usually produced in the form of humidity or condensate. This water is formed during the reaction of hydrogen and atmospheric oxygen supplied to the cathode side of the fuel cell, and thus it is formed during the process that is necessary for generating electricity. Moreover, a humidification of the anode gas of the fuel cell is desired.

At temperatures below the freezing point of water, however, there is a risk that, after the recirculation blower has been deactivated, water will precipitate in the gaps between stationary and rotary components of the recirculation blower and freeze therein, which would block the blower.

DE 103 14 820 A1 describes a method to prevent the freezing of water in the anode gas circuit of a fuel cell system, in which method the anode gas circuit, upon deactivation, is flushed with a dry flush gas to expel a volume of water present in the circuit. For instance, the flush gas may be dry pressurized air which is supplied into the anode gas circuit via an additional line and a suitable conveying means. A unit for dehumidifying this air or a tank for transporting this air is additionally required. Especially with mobile fuel cell systems, this unnecessarily increases the number and the weight of the components present.

### SUMMARY

Thus, it is an aspect of the present invention to provide an anode gas circuit for a fuel cell system and a method for activating and deactivating the anode gas circuit while preventing a freezing of the rotary components of the recirculation blower. The number and the complexity of the components to be used, and thus the overall weight of the fuel cell system, are to be reduced as compared with known embodiments.

In an embodiment, the present invention provides for an anode gas circuit of a fuel cell system. The anode gas circuit includes a return line leading from an anode gas outlet of a fuel cell stack to an anode gas inlet of the fuel cell stack, a recirculation blower disposed in the return line, a first valve disposed in the return line upstream of the recirculation blower, and a second valve disposed in the return line downstream of the recirculation blower. The first valve and the second valve are configured to close a cross section of the return line. The present invention also provides for a method for activating and deactivating an anode gas circuit of a fuel cell system. The method includes conveying in a recirculation blower an anode gas from an anode gas inlet of a fuel cell stack to an anode gas outlet of a fuel cell stack via a return line. Each of a first valve disposed upstream of the recirculation blower and a second valve disposed downstream of the recirculation blower are moved to a closed position when the recirculation blower is deactivated. Each of a first valve disposed upstream of the recirculation blower and a second valve disposed downstream of the recirculation blower are moved to an open position when the circulation blower is activated. Such a device and such a method make it possible to prevent the intrusion of additional humidity into the recirculation blower and to thereby prevent the formation of further condensate at the recirculation blower so that even when the water freezes at temperatures below the freezing point, a reliable operation of the recirculation blower is guaranteed. The effort for providing such a protective measure against a freezing of the recirculation blower is negligible compared with known embodiments.

### BRIEF DESCRIPTION OF THE DRAWINGS

The present invention is described in greater detail below on the basis of embodiments and of the drawings in which:

FIG. 1 is a schematic illustration of an anode gas circuit of the present invention at a fuel cell system; and

FIG. 2 is a sectional top plan view on a flange plane of a recirculation blower of an anode gas circuit of the present invention.

### DETAILED DESCRIPTION

In an embodiment of the device of the present invention, a heating element is situated in immediate proximity to the valves, whereas, in a development of the method, the heating element is used to heat the valves to a temperature above the freezing point prior to the activation of the recirculation blower. Condensate accumulating and freezing at the valves that can not reach the recirculation blower, is thawed up by the heating elements at the valves so that a reliable functioning of the valves occurs.

The valves can, for example, be arranged in a common plane and can be operated through a common actuator so that the number of components used is further reduced, while at the same time the synchronous opening of the valves at the inlet and at the outlet of the recirculation blower occurs.

In an embodiment of the anode gas circuit, the common plane is located in a housing of the recirculation blower in which an inlet channel and an outlet channel are formed. Such an embodiment facilitates the assembly of the anode gas circuit since the recirculation blower with the valves can be fit into the circuit as a unit so that the valves can be arranged in sufficient proximity to the recirculation blower, thereby reducing the effort in components and assembly work required for the valve unit at the housing of the blower.

In an embodiment of the present invention, the valves are designed as rotatable flaps that are each arranged on a rotatable shaft. This also offers advantages in manufacture and assembly, with these flaps being of particular advantage when used in areas with larger flow sections.

For a particularly simple actuation, the ends of the shafts are respectively provided with a pinion, both pinions meshing with a tooth rack operable via the actuator.

Since it is sufficient to design the flaps as open/closed valves, as provided in the present invention, the actuator can, for example, be in the form of a lifting magnet. Such a lifting magnet is economic, easy to control and precise with respect to its end positions so that a reliable closure of the anode gas circuit is guaranteed upstream and downstream of the recirculation blower after the same has been deactivated.

The lifting magnet can be sealed against the housing by means of a bellows. This reliably prevents the intrusion of hydrogen or water into the lifting magnet, whereby the life cycle of the actuator is significantly increased.

An anode gas circuit and a method for activating and deactivating the anode gas circuit are provided which reliably avoid freezing of the recirculation blower, while the number and the complexity of the components used are minimized so that the overall weight of the anode gas circuit is reduced at the same time.

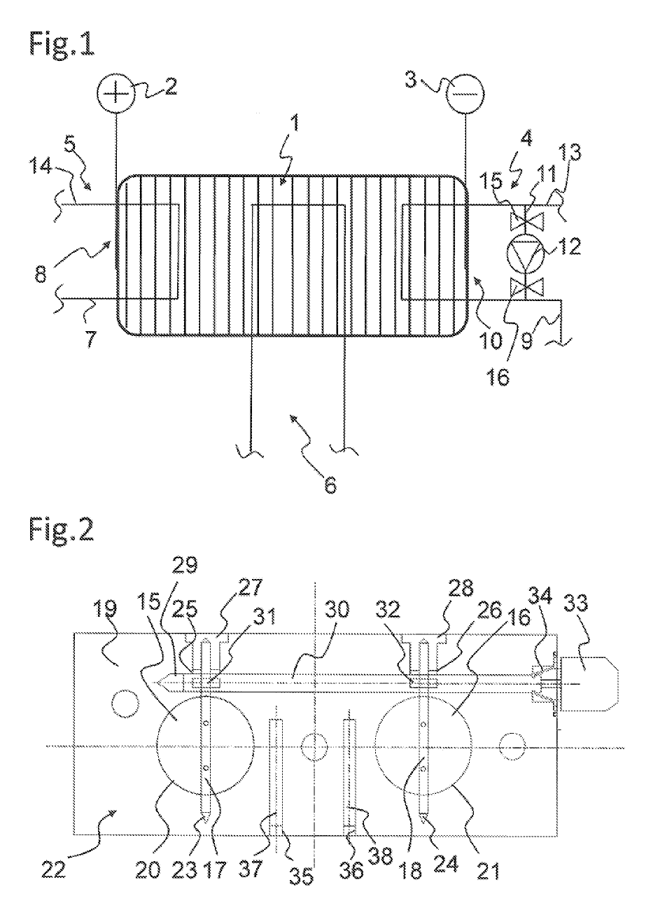

FIG. 1 illustrates a fuel cell stack 1 with a cathode 2 and an anode 3. This fuel cell stack 1 is connected to an anode gas circuit 4, a cathode gas circuit 5 as well as a cooling circuit 6.

The parts of the circuits 4, 5 and 6 that are not relevant to the present invention are not illustrated in the FIGURE, but they will be described shortly in an exemplary manner with reference to a typical structure of a PEM fuel cell system. The cathode gas circuit 5 may be formed by a compressor, for instance, which is driven via an electric motor and conveys air to the cathode side 8 of the fuel cell stack 1 via a line 7. At the same time, in the anode gas circuit 4, compressed hydrogen is fed from a low temperature reservoir to the anode side 10 of the fuel cell stack 1 via a pressure reduction valve and a control valve through a line 9.

On the anode side 10, the hydrogen is catalytically oxidized und transformed into protons while ejecting electrons in the process. The electrons are discharged from the fuel cell and flow through an electric consumer, such as an electric motor for driving a motor vehicle, to the cathode. At the cathode, the oxidizer, which is atmospheric oxygen in the present example, is reduced to anions by taking up electrons. At the same time, the protons diffuse through the proton exchange membrane between the fuel cells to the cathode and react with the reduced oxygen to form water vapor. In these reactions, electric power is generated that can be tapped through the cathode 2 and the anode 3.

In these reactions, the available hydrogen is not fully consumed so that the anode-side exhaust gases can be fed again to the anode side 10 via a return line 11. A recirculation blower 12 is arranged in the return line 11 for this purpose, which blower is usually designed as a side channel blower.

The exhaust gases of the anode side 10 that are not returned and consist of non-consumed hydrogen, nitrogen and water vapor, are fed to a catalytic burner via an outlet line 13 and a discharge valve, where the still existing hydrogen is transformed into water under addition of oxygen, which water may then be discharged into the environment together with the nitrogen.

The exhaust gases of the cathode side 8 are first supplied to a separator device via an outlet line 14 and a valve for the control of the operating pressure, in order to separate water from the exhaust gas, whereafter the non-consumed atmospheric oxygen and the nitrogen are discharged into the environment.

The cooling circuit 6 may be realized in many different ways, where both an air cooling and a liquid cooling can be realized. Accordingly, a detailed description of the cooling circuit will be omitted.

After the deactivation of the fuel cell system, the water vapor present in the anode gas circuit 4 usually condensates at the pipelines and possibly in the recirculation blower 12. At outside temperatures below the freezing point of water, the water vapor will thus freeze in the region of the narrow gap between the rotating and stationary components of the recirculation blower 12, thereby immobilizing the recirculation blower 12.

For this reason, valves 15, 16 are arranged immediately upstream and downstream of the recirculation blower 12, which valves are closed immediately after the deactivation of the fuel cell system and the recirculation pump 12. The condensate forming in the lines after the deactivation can no longer flow to the recirculation blower 12 via the pipelines but precipitates at the valves 15, 16.

An embodiment of valves 15, 16 and their arrangement is illustrated in FIG. 2 which is described hereinafter. Here, the valves 15, 16 are designed as flaps pivotable about their central axis and each mounted on a rotatable shaft 17, 18.

The recirculation blower 12 comprises a housing 19 with an inlet channel 20 and an outlet channel 21, both having a common plane 22 in which the flaps 15, 16 are supported. Accordingly, the valves (flaps) 15, 16 form a structural unit with the recirculation blower 12. FIG. 2 is a top plan view on this common plane 22.

While a first end of the shafts 17, 18 is respectively supported in blind bores 23, 24, their opposite second end is respectively supported in a throughbore 25, 26 in the housing 19, the throughbores 25, 26 being closed with bearing covers 27, 28 so that an egress of hydrogen from the housing 19 is reliably prevented. In the plane 22, perpendicular to the two parallel throughbores 25, 26, another bore 29 is formed in the housing 19, in which a tooth rack 30 is guided, meshing with two pinions 31, 32 which are arranged on the second ends of the shafts 17, 18 at least in a manner secured against rotation. The tooth rack 30 is connected with an actuator 33 which, as illustrated in FIG. 2, is advantageously realized as a lifting magnet 33. The lifting magnet (actuator) 33 is fixed to the housing 19 with a first end of a bellows 34 being interposed, the second axial end of the bellows 34 embracing the entire circumference of the tooth rack 30. Thereby, hydrogen is reliably prevented from escaping into the environment from the inlet channel 20 or the outlet channel 21 via the bore 29. When the lifting magnet 33 is actuated, its linear movement is converted into a rotational movement of the flaps 15, 16 via the pinions 31, 32.

Additionally, two further bores 35, 36 are formed in the plane 22, in which heating elements 37, 38 in the form of heating cartridges are respectively arranged near the flaps 15, 16. These heating cartridges 37, 38 serve to liquefy frozen water depositing as condensate at the flaps 15, 16 after the deactivation of the fuel cell system and which could immobilize the flaps 15, 16 before a start at temperatures below the freezing point. Thus, the function of the flaps 15, 16 is reliably secured even at temperatures below zero.

Before the fuel cell system or the anode gas circuit is started, the heating elements 37, 38 and, via the heating elements 37, 38, the flaps 15, 16 are heated first so that the water accumulated at the flaps 15, 16 is liquefied and the flaps 15, 16 can be opened without much force by means of the lifting magnet 33, the tooth rack and/or bore 36 and the pinions 31, 32. Thereafter the recirculation blower 12 is started. When the recirculation blower 12 is deactivated, the flaps 15, 16 are closed almost simultaneously by actuation of the lifting magnet 33 so that, while the system thereafter cools, the condensed water accumulating not flowing from the pipelines 9, 11, 13 into the recirculation blower 12, but will accumulate at the flaps 15, 16. At temperatures below the freezing point, this water will freeze only at the flaps 15, 16 and can, when the system is started, be liquefied at the flaps 15, 16 by means of the heating elements 37, 38 for a reliable functioning of the anode gas circuit 4.

An anode circuit for a fuel cell system and a method for activating and deactivating an anode gas circuit are thus provided, with which a freezing of the rotary components of the recirculation blower is avoided, since condensed water is prevented from penetrating through the flaps. The function of the latter is then guaranteed by heating. Compared with known devices, the structure of the device of the present invention is significantly less complex and it is easier to control.

It should be understood that different structural modifications are possible within the range of protection defined by the main claim. For instance, instead of the flaps illustrated, other valves may be used. Further, the flaps could be located in the pipelines immediately upstream or downstream of the blower, instead in the region of a flange of the housing. Of course, different types of transmissions or actuators are possible.

Although the present invention has been described and illustrated with reference to specific embodiments thereof, it is not intended that the present invention be limited to those illustrative embodiments. Those skilled in that art will recognize that variations and modifications can be made without departing from the true scope of the present invention as defined by the claims that follow. It is therefore intended to include within the present invention all such variations and modifications as fall within the scope of the appended claims and equivalents thereof.

What is claimed is:

1. An anode gas circuit of a fuel cell system, the anode gas circuit comprising:
a return line leading from an anode gas outlet of a fuel cell stack to an anode gas inlet of the fuel cell stack;
a recirculation blower disposed in the return line;
a first valve disposed in the return line upstream of the recirculation blower; and
a second valve disposed in the return line downstream of the recirculation blower;
wherein the first valve and the second valve are configured to close a cross section of the return line.

2. The anode gas circuit as recited in claim 1, further comprising a first heating element and a second heating element each disposed in an area of a respective one of the first valve and the second valve.

3. The anode gas circuit as recited in claim 1, wherein the first valve and the second valve are disposed in a common plane and further comprising an actuator configured to actuate the first and second valves.

4. The anode gas circuit as recited in claim 3, wherein the recirculation blower includes a housing, wherein the common plane is disposed in the housing so as to form an inlet channel and an outlet channel.

5. The anode gas circuit as recited in claim 3, wherein the actuator includes a lifting magnet.

6. The anode gas circuit as recited in claim 5, further comprising a bellows configured to seal the lifting magnet against an interior of a housing of the recirculation blower.

7. The anode gas circuit as recited in claim 1, wherein the first valve and the second valve each include rotatable flaps disposed on a shaft.

8. The anode gas circuit as recited in claim 1, further comprising a first pinion disposed on an end of a first shaft and a second pinion disposed on an end of a second shaft, the first pinion and the second pinion each meshing with a tooth rack operable via an actuator.

9. A method for activating and deactivating an anode gas circuit of a fuel cell system, the method comprising:
conveying in a recirculation blower an anode gas from an anode gas inlet of a fuel cell stack to an anode gas outlet of a fuel cell stack via a return line;
moving each of a first valve disposed upstream of the recirculation blower and a second valve disposed downstream of the recirculation blower to a closed position when the recirculation blower is deactivated; and
moving each of a first valve disposed upstream of the recirculation blower and a second valve disposed downstream of the recirculation blower to an open position when the circulation blower is activated.

10. The method for activating and deactivating an anode gas circuit of a fuel cell system as recited in claim 9, further comprising:
heating the first valve and the second valve to a temperature above a freezing point of water before the recirculation blower is activated, wherein the heating of the first valve and the second valve is performed using a first heating element and a second heating element.
